(19) United States
(12) Patent Application Publication
(10) Pub. No.: US 2026/0198726 A1
(43) Pub. Date: Jul. 16, 2026

(54) ACTIVE, CONTROLLABLE, REDUCED TEMPERATURE BEVERAGE MAKING APPARATUS, SYSTEM, AND METHOD

(71) Applicant: BUNN-O-MATIC CORPORATION, Springfield, IL (US)

(72) Inventors: John D. BISHOP, Springfield, IL (US); Josh CRAIG, Springfield, IL (US); Chairil V. MCCLAIN, Springfield, IL (US); Paul WELCH, Springfield, IL (US)

(21) Appl. No.: 19/283,031

(22) Filed: Jul. 28, 2025

Related U.S. Application Data
(63) Continuation-in-part of application No. PCT/US2024/013304, filed on Jan. 29, 2024.
(60) Provisional application No. 63/441,662, filed on Jan. 27, 2023.
(60) Provisional application No. 63/703,763, filed on Oct. 4, 2024.

(51) Int. Cl. A47J 31/52; A47J 31/46

(52) U.S. Cl. CPC A47J 31/5253; A47J 31/461; A47J 31/469

(57) ABSTRACT

Disclosed is an apparatus, system, and method for making beverages using controllable temperature brewing techniques. The controllable temperature brewing uses brewing water within an approximate a target range of 100° F. to 207° F. Included are additional brewing controls, including a controllable air pump to pressurize the water flow through a spray head with a selectively controllable additional pressure within the range of approximately 0.25 to 0.50 psi pressure. One embodiment uses two controllable proportional water valves, one on the ambient water line and one on the tank inlet line. The two controllable proportional control valves help to control the water temperature to provide a wide range of controllable water temperatures. The apparatus, system, and method produces beverages and beverage concentrate that can be consumed as is or used in other beverages such as cold brew beverage recipes for use in preparations for final mixed beverages. The apparatus, system, and method produces the resultant beverage in significantly less time than traditional beverage making methods.

### CROSS REFERENCE TO RELATED APPLICATION

This application is a Continuation-in-Part application filed under 35 U.S.C. § 111(a) claiming the benefit of priority of prior-filed application under 35 U.S.C. § 120 and 365(c) to International Application No. PCT/US 2024/013304, international filing date of Jan. 29, 2024, which claims the benefit of U.S. Provisional Application Ser. No. 63/441,662, filed Jan. 27, 2023, and further the present application claims the benefit of priority to the prior-filed application under 35 U.S.C. § 119(e) U.S. Provisional Application Ser. No. 63/703,763, filed Oct. 4, 2024. This application also incorporates herein by reference in their entirety the subject matter set forth in of all of the above specified applications which are owned in the entirety by the Applicant of the present application.

### BACKGROUND

The following provides information relating to the apparatus, system, and methods for operating a device to produce a brewed beverage at a reduced temperature. The apparatus, system, and method uses an active brewing technique similar to hot brewing techniques and is controllable to produce resultant brewed beverages at reduced temperature having flavor and mouthfeel characteristics similar to cold brewing techniques.

Traditionally brewed beverages have been “brewed” by infusing a brewing substance with heated water. As an example, a variety of teas are brewed at temperatures ranging from 165° F. to 205° F. (approximately 75° C. to 95° C.). Similarly, coffee has been brewed at temperatures of 190° F. to 205° F. (approximately 87° C. to 95° C.). This brewing process infuses the brewing substance with heated water to help transfer chemicals and other substances within the ground coffee, tea or other substances and transfers it to the water. Heating of the water helps promote the transfer of these characteristics.

The traditional heated brewing technique or “hot brewed” beverages tend to extract different characteristics than other techniques. As an example, such hot brewing techniques might produce a brighter taste, with more “perceived” acidity, and sometimes more astringent flavors. The hot brewed technique tends to produce the brewed beverage relatively rapidly since the energy in the heated water tends to extract flavors relatively quickly. As such, the hot brewing technique tends to try to not maintain too long of a contact with the ground coffee to prevent “over extraction” of the chemicals and other components of the ground coffee that contribute to the flavor and characteristics of the finished coffee.

In the beverage category of coffee, a variety of techniques also have been developed to brew beverages at a chilled or ambient temperature. As an example, the slow-drip “cold brew” technique referred to as Kyoto-style or Dutch coffee uses water is slowly dripped through a dose of coffee grounds over a long period of time. Similarly, in a process referred to as TODDY® (a registered trademark of Toddy, LLC), a volume of ground coffee is placed in some form of filter and allowed to slowly soak in a volume of cold or ambient temperature water over a long period of time to extract flavoring chemicals and other characteristics from the mixture of ground coffee with water. In both the Kyoto-style and Toddy-style techniques, the cold brewing process may take approximately 12-24 hours, depending on the recipe, to produce the brewed beverage. The finished cold brewed coffee is used for drinking straight as a beverage, or as the component in a mixed cold coffee beverage. An example of a mixed cold coffee beverage could be, but is not limited to, a sweetened cold coffee cappuccino, which has a recipe that combines the cold coffee with cold milk and a sweetener. The proportions depend on the recipe, but the goal of this beverage is to provide the consumer with a cold coffee equivalent of a hot coffee cappuccino. The ability to offer cold coffee beverages expands to the coffee seller's offerings and consumer choices possibly leading to expanded sales opportunities and consumer satisfaction.

It would be desirable to produce brewed beverages for use in cold or chilled beverage serving that maintains many of the flavor and other beverage characteristics of “cold brew” but takes significantly less time than 12-24 hours. It is also desirable to find a brewing technique that has processing speeds and operational efficiencies comparable to hot brewed coffee but maintains the same or similar characteristics of cold brew but not the characteristics of hot brewed coffee.

It would be preferable to develop a way to produce a brewed beverage such as coffee having the characteristics of flavor, complexity and other nuances similar to a cold brewed coffee without having to spend 12-24 hours waiting for the production of this beverage. It has been found that it is generally not acceptable to simply brew coffee using a hot brew technique beverage and pour it over ice since brewing a beverage with hot water will retain the characteristics of the hot brewed coffee and not the flavor characteristics of the cold brewed coffee.

This background information is provided to provide some information believed by the applicant to be of possible relevance to the present disclosure. No admission is intended, nor should such admission be inferred or construed, that any of the preceding information constitutes prior art against the present invention. Other aims, objects, advantages and features of the invention will become more apparent upon reading of the following non-restrictive description of specific embodiments thereof, given by way of example only with reference to the accompanying drawings.

### BRIEF DESCRIPTION OF THE DRAWINGS

The present disclosure will be described hereafter with reference to the attached drawings which are given as a non-limiting example only, in which:

FIG. 1 is a simplified diagrammatic illustration of an apparatus used in the production of beverages using controllable components to consistently and repeatedly produce a recipe using water that is below a hot brew technique temperature range and above a cold brew technique temperature range, while providing operational efficiencies that are significantly improved compared to cold brew techniques, and while providing flavor characteristics significantly similar to cold brew techniques;

FIG. 2 is a diagrammatic electrical schematic of the components as shown generally in FIG. 1;

FIG. 3 is a simplified diagrammatic illustration of an embodiment of the apparatus used in the production of beverages using controllable components to consistently and repeatedly produce a recipe using water that is below a hot brew technique temperature range and above a cold brew technique temperature range, while providing operational efficiencies that are significantly improved compared to cold brew techniques, and while providing flavor characteristics significantly similar to cold brew techniques; and

FIG. 4 is a simplified diagrammatic illustration of another embodiment of the apparatus used in the production of beverages using controllable components to consistently and repeatedly produce a recipe using water that is below a hot brew technique temperature range and above a cold brew technique temperature range, while providing operational efficiencies that are significantly improved compared to cold brew techniques, and while providing flavor characteristics significantly similar to cold brew techniques, and providing an alternative flow path for the introduction of air to the mix tube.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways within the teaching provided herein. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

Terms including beverage, brewed, brewing, brewing substance, brewed liquid, and brewed beverage as may be used herein are intended to be broadly defined as including, but not limited to, the brewing of coffee, tea and any other beverages. This broad interpretation is also intended to including, but is not limited to beverage substances such as ground coffee, tea, liquid beverage concentrate, powdered beverage concentrate, flaked, granular, freeze dried or other forms of materials including liquid, gel, crystal or other forms of beverage or food materials to obtain a desired beverage or other food product using the structures and methods disclosed herein.

Beverage ingredients will be described in the present application and will be generally referred to as “coffee”. However, it should be understood that the term beverage brewing substance should be broadly interpreted regardless of reference to the specific beverage ingredient or coffee. Reference to beverage dispensing includes reconstituting, brewing, steeping or any other form of combining a dilution ingredient such as water with a beverage ingredient, such as coffee. Furthermore, use of a dilution ingredient is to be broadly interpreted. While “water” is referred to for convenience throughout the application, it should be understood that any variety of dilution ingredients could be used with the present application.

The foregoing terms as well as other terms should be broadly interpreted throughout this application to include all known as well as all hereafter discovered versions, equivalents, variations and other forms of the abovementioned terms as well as other terms used herein. The present disclosure is intended to be broadly interpreted and not limited.

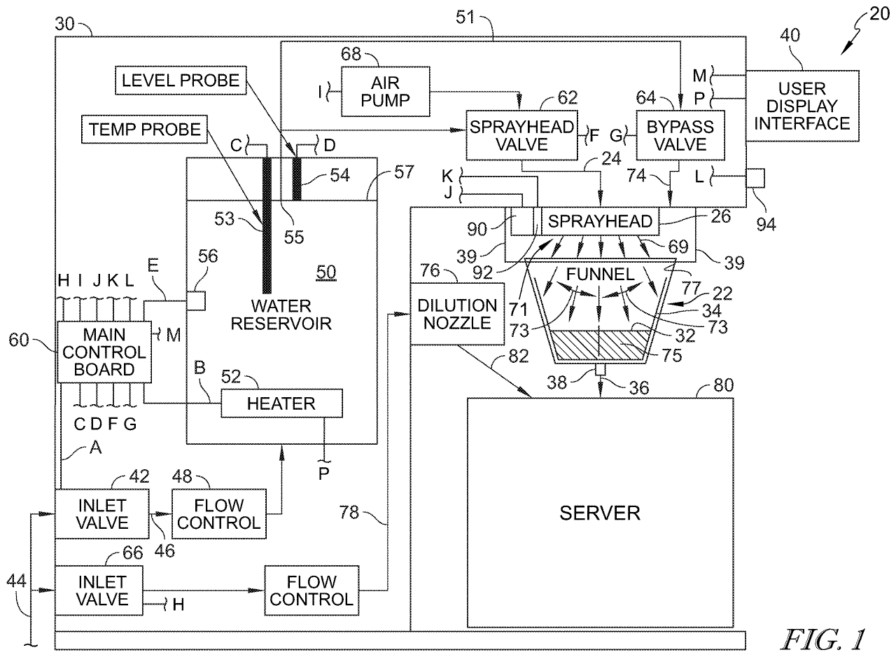

With reference to FIG. 1, an apparatus 20 is shown including structure and components which function for controllably and repeatedly providing a means and system to operate using methods of a novel brewing technique. The novel brewing technique operates using brew water temperatures that are significantly lower than hot brew techniques and higher than cold brew techniques. The apparatus, system and methods disclosed herein provide the benefits of significant operating efficiencies to produce a beverage having characteristics similar to a cold brew technique beverage. The present apparatus, system, and method is described herein as an “active” brewing technique as compared to a “passive” brewing technique such as is used in cold brewing systems. An example of a passive cold brewing technique might be the Toddy® system which employs a container for retaining a filter and in which is placed a charge of ground coffee. Cold or ambient temperature water is placed in the container with the coffee to allow the coffee and water to steep for an extended period of time. This is passive since there is no other activity generally required for the production of a brewed beverage. Using the Toddy system the operator waits 12-24 hours to produce the brewed beverage at which time the filter material containing the ground coffee, now saturated with water, to allow to drain. Draining generally occurs under the force of gravity by elevating the filter material above the liquid in the container thereby allowing the saturated coffee grounds to drain into the container. However, sometimes the person preparing the coffee tries to accelerate the process and squeezes the saturated coffee in the filter material. This can be motivated by impatience or need when the coffee café runs out of cold coffee beverage for serving to customers. This generally does not follow the preferred and/or recommended cold brewing process since the generally preferred process has been developed based on gravity draining. The use of a squeezing technique to compress the saturated coffee grounds tends to over extract the coffee and introduces undesired flavor and mouth feel characteristics.

While this passive technique produces beverage characteristics that are desirable for some consumer tastes, this passive technique takes a significant amount of time to brew requiring operational considerations. As an example, an owner (the party who owns the business serving coffee) using such a passive technique must plan for a significant amount of time and anticipate consumer demand for cold brewed beverage. Waiting 12 to 24 hours does not allow the owner to be responsive to rapid changes in consumer demand or unanticipated problems with the brewing equipment or technique.

As another example, if the owner making the cold brew coffee misjudges the demand for the coffee they could be caught without a sufficient supply of coffee to meet the demand; missing sales opportunities. Additionally, if there is misjudgment in the other direction such that the operator anticipates a significantly greater demand than what actually occurs, then the operator will end up wasting brewed beverage and the related activities associated with the cold brewing process.

There are also other types of issues that could occur with a cold brewing technique such as preparing all of the cold brewing containers including coffee and water but then spilling some of the ingredients or the full container. This could result in having too small a volume of resultant coffee to meet demand and having to wait 12-24 hours to brew a replacement batch. Similarly, the placement of these containers for an extended period of time while the coffee steeps increases the chance that such an accident could occur and as such requires a significant investment in space to accommodate this brewing technique. Associated with this demand for space is the risk of contamination such that if the container is unsealed, contaminants could enter the brewing process. The risk of spilling and contamination is also increased since the containers must be placed somewhere and if they are placed amongst uncooked food or other ingredients, the ingredients unintentionally could be unintentionally or accidentally introduced to the cold brew containers in the intervening time. This could be exacerbated since the cold brew technique takes a significant period of time during which such contaminants could spoil the batch of cold brew beverage.

Other operational issues may arise with the passive technique such that it requires employees to take time to clean the containers in a manual method, clean the filter material in a manual method, invest in significant employee planning time in order to accommodate the ups and downs of demand, invest in significant employee training and dedication to make sure employees are educated about recipes and to make sure that ingredients are properly mixed in proper quantities since there is little room for error if a batch is spilled, spoiled, or improperly mixed. In addition, employees must move relatively large containers of ground coffee saturated with water ranging from 2.5 to 5 gallons weighing approximately 22.5 pounds to 5 pounds, including the weight of the ground coffee in a 1 pound of coffee to I gallon of water ratio. Due to these operating characteristics, cold brew techniques such as Toddy-style systems often are used to brew a concentrate, which is then later diluted. While there are some benefits to this technique the use of this type of concentrate with little or no room for error can produce other operational issues.

At the other end of the spectrum is the use of a hot brew technique. While hot brewing techniques provide some efficiencies they cannot generally produce the flavor and other beverage characteristics that are desirable in a cold brewed beverage. The hot brew techniques tend to produce a coffee with a brighter flavor and more perceived acidity, which is acceptable and in fact desirable for hot coffee beverages, but may not be so for cold brew coffee beverage expectations. While some have tried to produce a cold beverage (not cold “brewed”) using hot brewed technique beverage poured over ice or chilled, this generally does not match consumer expectations for a genuine “cold brewed” beverage. When a consumer orders a cold brewed beverage, they expect the flavor characteristics of cold brewing using techniques such as Kyoto-style or Toddy. The flavors associated with the cold brew techniques tend to be sweeter, smoother, less bitter and less perceived acidity. It should be noted that there is nothing wrong with the flavor characteristics of either brewing technique, hot or cold, but there should be a match between consumer expectations and the beverages and the characteristics of the beverages they receive in response to their beverage selection.

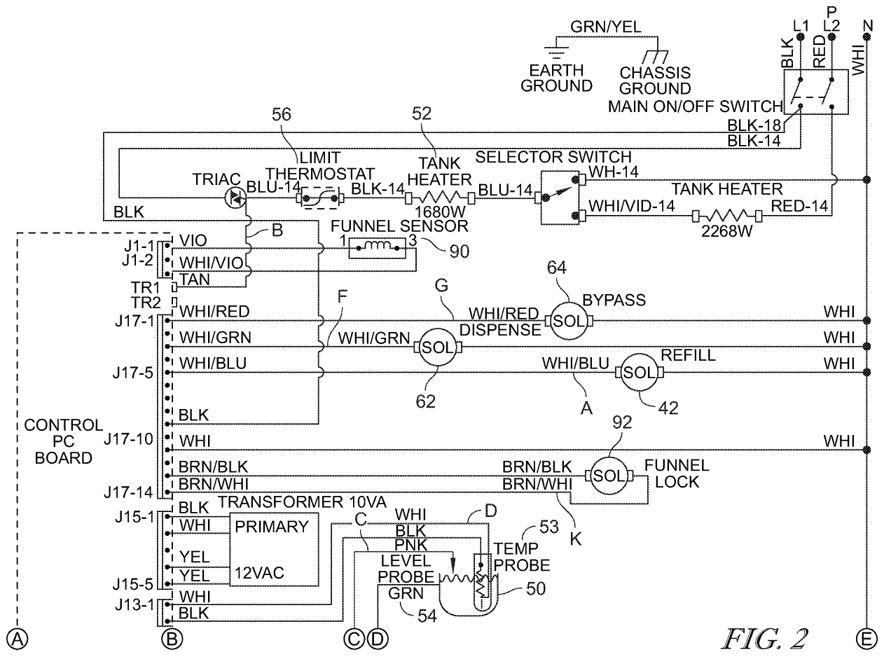

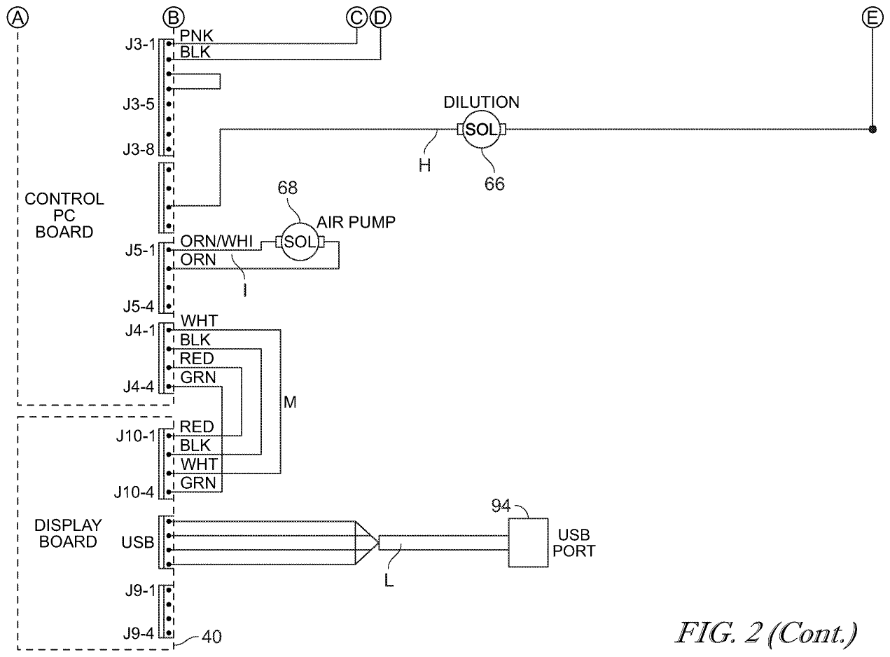

The apparatus disclosed in FIGS. 1 and 2 and described in greater detail hereinbelow provides a novel apparatus, system, and method of brewing coffee having flavor characteristics substantially similar to those produced by traditional cold brew techniques while having significant operational efficiencies and significantly reduced preparation time. The apparatus 20 provides structures and functions that are designed to provide significant control of the recipe used to produce the beverage thereby providing a repeatable and consistent beverage product. The apparatus, system, and method also allows the operator to choose whether to produce a concentrate or a ready to drink beverage using the technique disclosed herein. The present apparatus provides the means to produce a beverage having desired characteristics while not requiring 12-24 hours of steep time nor requiring the space or integrity commitment of several relatively large containers of fluid passively steeping coffee.

The present apparatus has a “footprint” similar to other hot brew technique beverage making machines, commonly referred to a “brewers”, such as apparatus used in coffee shops, restaurants, and kitchens. In addition, the present apparatus, system, and method is relatively “forgiving” in its operation such that it can brew in a relatively short period of time thereby allowing for correction if the recipe is miscalculated or some of the beverage is somehow accidentally spilled. This operational forgiveness in the system allows an owner/employee to correct promptly by reloading the apparatus to execute another brew cycle using the methods of the present disclosure. In this regard, the operator of the present apparatus can always have freshly brewed concentrate or ready to drink beverage, using the same apparatus to produce both type of brew, to meet customer demands even when there is a surge in customer demand. Similarly, if there is a reduction in expected customer demand during a given operating shift, the owner merely needs to brew enough beverage to have on hand at the given time. The operator has the confidence of knowing they can relatively quickly make more coffee, not having to wait 12-24 hours as with traditional cold brewing techniques. These operating efficiencies result in significant bottom line benefits such that less coffee is wasted while constantly meeting the demand of the consumers.

The present apparatus also eliminates the need for the employee operating the machine to interact in a significant way with the process in order to help improve the consistency of the process. In this regard, the owner of the apparatus can have the employee execute prescribed recipes which are manually executed from a prescribed recipe, stored in the machine as operation recipe, or can be added to the machine as an operation recipe through use of media such as a USB stick. These recipe choices allow for a more complex choice of recipes to be designed by the owner to produce a better coffee experience for the customer. This is in comparison to the generally limited recipe choices associated with a cold brew technique, such as soaking the ground coffee in water to a defined period of time.

The employee merely needs to deposit a defined dose of ground coffee 32 to a funnel 22 for brewing with brew water 24 dispensed into the funnel through a spray head 26. The dose or quantity of coffee can even be prepared and delivered in a premeasured package, labeled with the coffee contents, referred to as a fractional pack or “frac pack”. The frac pack can then provide the employee with the proper volume dose having the specific type of coffee and the appropriate grind of the coffee as prescribed in a particular recipe.

With further reference to FIG. 1, the apparatus 20 includes a housing 30 proving structure to position and contain components of the apparatus. To use the apparatus 20 a user places the brewing substance 32, such as coffee, within the funnel 22. Customarily, a filter component 34, such as a paper or reusable filter of known construction, is provided within the funnel 22 to contain the coffee 32 and allow a resultant beverage 36 to flow therethrough and out through a funnel drain aperture 38. Once the funnel 22 including the coffee 32 has been positioned on a retaining structure 39 of the housing 30, the operator of the apparatus can choose a recipe at the user display and control interface or interface 40. The interface 40 is a type that includes information to allow the user to control the apparatus. Once a recipe is selected for the upcoming brewing cycle the operator activates the cycle using a “start” button or other control at the interface 40 to initiate the brew cycle defined by the selected recipe.

Once the brew cycle is initiated, a reservoir inlet valve 42 connected to an inlet water line 44 is operated. The reservoir inlet valve may be in the form of an electrically controllable solenoid valve that is in a normally closed position and electrically operated to an open position as defined by the selected recipe. Operation of this valve allows a prescribe volume of water, based on the recipe, to flow through the line 46 and flow control device 48. Water entering through the reservoir inlet valve flows into a water tank 50 where it can be heated by a controllable heater 52. As noted within this disclosure, the heating is targeted for a range of approximately 100° F. to 150° F. (approximately 38° C. to 66° C.). The reservoir retains water at this temperature for the brewing process as disclosed to achieve the characteristics of the beverage as described herein. A level probe 54 is provided to monitor the level of the water within the reservoir 50. A thermostat 56 is coupled to the reservoir 50 to monitor the temperature of the water in the reservoir 50 to maintain it within the desired temperature range for brewing as described herein.

The components associated with the reservoir 50 as described herein are coupled to a control system or controller 60. The inlet control valve 42 is controllably coupled to the controller 60 over line A. The heater 52 is controllably coupled to the controller 60 over line B. The temperature probe 53 is coupled to the controller 60 over line C. The level probe 54 is coupled to the controller 60 over line D. The limit thermostat 56 is coupled to the controller 60 over line E. Once the reservoir is confirmed to be at the appropriate level by detection with level sensor 54 and is at the appropriate temperature as detected by thermostat 56 the controller 60 allows the system to operate according to the recipe by controlling delivery of water via a controllable spray head valve 62, a controllable bypass valve 64 (if required by the recipe), controllable dilution valve 66 (if required by the recipe), and operation of a controllable air pump 68 coupled to the spray head valve 62. The spray head valve 62 is controllably coupled to the controller 60 over line F. The bypass valve 64 is controllably coupled to the controller 60 over line G. The dilution water inlet valve 66 is controllably coupled to the controller 60 over line H. The air pump 68 is coupled to the controller 60 over line L.

During the operation of the brew cycle, water is added to the spray head 26 by control of the spray head valve 62 controlling water flow through line 70 to the spray head 26. A calculation is provided and retained on the controller 60 and/or the recipe of a time required to fill the volume associated with a particular spray head 26. When this volume is dispensed by the water system components additional steps in the water distribution and flow control process can occur. This step is provided so that each of the subsequent steps and operations used to brew the beverage in the funnel 22 can provide operative results.

As an example, the air pump 68 is controlled on and off to increase pressure and relieve pressure of the water 24 flowing through the spray head valve 62. The action of the air pump 68 on the water 24 flowing to and through the spray head 26 helps to create an enhanced pressurization of the water in the spray head 26. During this portion or step of the brewing process of this invention, the pressure of water 69 flowing out of the spray head 26 is increased ¼ psi to ½ psi. This action tends to cause the spray 71 emanating from the spray head 26 to increase and decrease in diameter 73 relative to the centerline 75 of the internal structure of the funnel 22. The increased pressure tends to cause greater velocity of the flow coming out of the spray head 26. The spray head 26 includes numerous openings generally of a relatively small diameter to control the direction of flow over the beverage brewing substance. By increasing the pressure through these holes, the water tends to spray outwardly away from the centerline 75 of the funnel 22. When the air pump 68 is turned off by the controller 60, the pressure is relieved and the water flow 24 returns to the original flow pressure through water line 24. When the pressure is relieved, the flow pattern 73 generally slightly decreases it tends to draw the spray pattern inwardly towards the centerline 75 of the funnel 22.

The combination of ground coffee which has been wetted and water tends to create a “slurry” of material within the filter material retained in the funnel 22. This increased pressure and relieved pressure creating the outwardly produced spray pattern and inwardly relieved spray pattern 75 provokes agitation and movement of the ground coffee within the water being dispensed over the ground coffee. This agitation helps to increase the interaction between the water and the coffee grounds to enhance the effect of the infusion process on the coffee grounds during the brewing cycle. This action is desirable since it can be used as a recipe component by enhancing the activity and extraction of characteristics when using lower temperature water within the range of approximately 100° F. to 150° F.

In addition, the controllable bypass valve 64 provides a flow of water over line 74 which does not pass directly through the spray head 26. The flow of bypass water comes from the water reservoir 50 via waterline 51 which extends into the reservoir at it intake end 55. The intake end 55 generally extends to the full water level 57 as also detected by the level probe 54. The flow of water through line 74 is directed to an area between the filter material 34 and the funnel interior surface 77 to add water to the brewing cycle but not add water directly applied to the coffee 32 in the funnel 22. In this regard, bypass water 74 can be used to achieve a different mix of liquid added to the beverage extracted from the ground coffee to enhance or otherwise modify characteristics of the brewed beverage created by the apparatus consistent with a defined recipe. The bypass valve 64, coupled to the controller 60 can be operated continuously throughout the brewing process, operated on and off during the brewing process through a prescribed set of steps, or remain off during the brewing process.

Further, a controllable dilution valve 66, coupled to a dilution nozzle 76 over line 78, can be used to dilute beverage 36 produced through the brewing process and dispensed from the funnel 22 into a server, dispenser, carafe or other container 80. Dilution water can be controllably dispensed into the server 80. The dilution nozzle 76 and control can be an effective way to dilute a concentrate brewed from coffee 32 retained in the funnel 22. In this regard, a recipe may be designed to brew a concentrate containing various characteristics and flavors associated with the desired resultant brewed beverage. The recipe using such a concentrate can be controllably modified or additionally followed, by dilution after brewing to a desired range of characteristics as well as a controllable range of temperatures.

Dilution water 82 can also be used in a recipe separate from the bypass water to produce a different temperature resultant beverage in the server 80. In this regard, the bypass water 74 is provided to the funnel 22 and the resultant beverage stream 36 at the same temperature as the water flowing through line 70 used to brew the beverage. The bypass water 74 is dispensed from the reservoir 50 and has the same temperature as the brewing water 24 This provides a resultant beverage that is brewed to a concentrate, modified with some bypass water, and then retained at an original prescribed temperature based on the resultant temperature after the brewing.

In contrast, the same concentrate can be brewed using water from the water reservoir 50 to create a desired resultant beverage 36 without the addition of bypass water. However, if the recipe calls for a resultant beverage having similar characteristics one that might be achieved with bypass water but requires a lower resultant temperature, the dilution valve 66 can be operated to provide water 82 to the brewed concentrate in the server 80. Since the water 82 flowing from the main water line 44 is not heated, it will be an ambient or cooler temperature depending on the water source. The use of reduced temperature beverage from the server 80 can be useful in producing chilled coffee, iced coffee, or blended coffee frozen beverage. Use of the dilution valve 66 to provide water 82 to the server 80 allows a desired beverage 36 to be brewed to achieve the various characteristics desired for flavor, mouth feel, other components provided at some slightly elevated temperature as defined herein but producing a beverage at a controllably reduced temperature.

In addition, the present apparatus 20 includes a funnel sensor 90 coupled to the controller 60 overlying J and a funnel lock component 92 controllably coupled to the controller 60 over line K. The funnel sensor 90 is used to detect the presence of the funnel 22 and to lock out the system from operating until the funnel 22 is present on the structure 39 and prevent unintended dispensing of water without a funnel 22 present. The funnel lock 92 is used to lock the funnel 22 in place once detected by the funnel sensor 90 during the start of a brew cycle to prevent unintended removal of the funnel 22 during the brew cycle.

A USB port or device 94 where other data/information transfer device can be provided on the apparatus 20. Such a device 94 can be in the form of a USB port, other connectors, a passive or active inductive coupling device, or any other information/data transfer device that currently exists or is hereafter created for this purpose. This allows owners to connect to the apparatus 20 and the controller 60, coupled to the device 94 over line L, to allow for the modification of recipes, loading of recipes, updating of software, and related functions. This device 94 can also be provided by way of a wireless, wired, optical, magnetic, or other connection to communicate and otherwise transfer information remote from the apparatus 20.

A recipe can be designed for a brew cycle using pulses of water, to controllably dispense water from the spray head 26 and into the funnel 22 for a combination with the beverage brewing substance 32. This pulsing is achieved by controlling the spray head valve 62 to be opened and closed at prescribed times and for prescribed lengths to achieve the desired pulsing routine. Generally, a predetermined volume of water is prescribed in the recipe to be dispensed over the brewing substance 32. This volume of water can be divided over a specific, predefined period of time relating to the entire brew cycle to deliver pulses of equal size with pulses of “off” time of equal size or other variations in length to increase or decrease both the pulsing of water into the funnel as well as the off times. An initial on pulse, followed by an initial off pulse or pause at the start of the brew cycle can be used to “pre-infuse” the ground coffee. Such a pre-infusion start can be used to cause the coffee to out-gas or bloom. This allows for some degree of water to be added to the coffee to allow it to be initially wetted or saturated. Such pre-infusion can be used to enhance the interaction of water with the ground coffee later during the process and enhance the wetting of the ground coffee through the remainder of the brewing process. The duration and volume of water used in the pre-infusion wetting as well as the off pulse is fully controllable as a component of the predefined recipe.

In addition, the control of the air pump 68 during the brewing process can be used to pulse pressurized water 24 to provide the spray patterns 73 as described herein. Generally, a recipe will be designed and programmed to synchronize or otherwise coordinate air pump 68 control with the spray head 62 control. In this regard, it is desirable to provide the elevated pressurization of the water flow while the spray head valve is open and the spray head has water retained within it. As previously noted, an initial time may be required to introduce water to the spray head 26 so that there is a volume of water that can be pressurized by operation of the air pump 68. The control of the air pump is another element of the recipe that can be configured by the owner of the apparatus 20 to control the extraction of various characteristics and flavors from the ground coffee. As such, the recipe can be designed to include an air pulse with every water pulse or controlled to have air pulses on during some, but not all of the water pulses. In addition, the air pump 62 can be controlled to be off during the entire brewing cycle if that is what is necessary to achieve the desired characteristics of the resultant coffee 36 defined by the selected recipe.

Similarly, the bypass valve 64 and dilution valve 66 can be controlled as part of the recipe to continuously add water from these components, intermittently add water from these components depending on control of the spray head valve 62 and air pump 68, or at the end of the brewing cycle.

As noted, the construction of the apparatus 20 is such that it can provide a variety of controllable processing components to achieve a wide variety of recipe controls within a limited footprint. Typically, such an apparatus will be positioned on a countertop at a coffee shop, restaurant, convenience store, or other establishment. This allows the owner of the apparatus to confine the apparatus to a limited space that can be managed and maintained for security, sanitation, and to prevent accidental spilling of the beverage. As noted herein, use of the other passive “cold brew” devices typically come with the possible risk of contamination and spilling due to operator error. In addition, the use of the present controllable, active brewing apparatus 20 helps to provide a wide variety of recipe choices and controls that do not have to be set by the employee every time they run a brew cycle. Rather, the employee can choose, using the interface 40, a recipe that matches the desired result in beverage, and associated with the beverage material placed in funnel 22, and press the start button to allow the apparatus 20 to carry out all of the detailed and nuanced operation steps.

In addition, the present apparatus brews quantities of beverage ranging from approximately 1 gallon to 1.5 gallons (approximately 3.75 liters to 5.60 liters). If, inadvertently, an employee uses the wrong recipe or the wrong coffee for the selected recipe, only a few minutes will have passed to complete the brew cycle at which time the employee can remove the dispenser 80 and either use the resultant beverage at a later time, or dump the beverage and start with a new brew cycle. Since this apparatus 20 produces beverages having characteristics similar to a cold brew method but in dramatically less time (6-15 minutes with the apparatus 20 compared to 12-24 hours with a cold brew process) an accidental brewing does not prevent or create the loss of beverage sales throughout an entire day.

In addition, the present apparatus uses generally positively pressurized water flow systems flowing based on inlet line 44 water pressures without additional elevated pumping pressures or vacuum components. This can be beneficial for this particular brewing process to reduce the maintenance and other related functions and costs that might be otherwise required for higher pressurized water and vacuum operated systems. While an air pump 68 is used, it only provides a slightly elevated pressure of ¼ psi-½ psi and such pressurization happens intermittently. This pressurization does not occur throughout the entire process as might occur with some other elevated pressurized systems such as espresso brewers. In addition, the absence of a vacuum system associated with the present apparatus is beneficial for this particular process since it eliminates the need to manage issues that can occur with vacuum systems such as clogged vents and accumulation of other materials within the system.

The present apparatus 20 is an active brewing process that occurs over a brewing cycle that is completed within a few minutes. This is in contrast to passive brewing systems that produce similar beverage characteristics requiring a brew cycle of many hours, such as 12-24 hours for typical ambient temperature passive brewing systems.

A further benefit of the present system is that it provides a reservoir of water available for brewing on demand. This brewing water is gently heated to a temperature range significantly below traditional hot brewing temperatures by having some additional heat energy to enhance the brewing process and expedite the brewing process. This reservoir can maintain the desired low level temperature targeted for a range of approximately 100° F. to 150° F. (approximately 38° C. to 66° C.) and produce coffee beverage 36 in back-to-back brewing cycles over a significant period of time. The heater 52 is sized and specified to provide heat energy to the water retained within the reservoir 50 so that the system can keep up with generally continuous back-to-back brewing cycles, when required. This heater can operate at a relatively low energy usage level to manage and conserve energy and contain operating costs. This is in contrast to on-demand or flash water heaters that do not require maintaining a volume of water at some lower level temperature range but use a significant amount of energy to rapidly heat and otherwise elevate the temperature of water in a very short period of time. In addition, the present apparatus can be installed using a common 110V line. In contrast, on demand heaters typically require a 220V line to produce the dramatic power surge required to rapidly heat water. The operation of the present apparatus 20 significantly saves operating costs and installation time associated with the apparatus compared to on-demand systems.

As noted above, various recipes can be designed for use with the apparatus 20 and methods performed by the apparatus. In this regard, recipes can include to greater or lesser degrees controls related to, but not limited to, the following brewing control elements:
The temperature of brew water from the water reservoir, generally within the temperature range of approximately 100° F. to 150° F. (approximately 38° C. to 66° C.);
volume of coffee;
volume of water;
grind size of the coffee;
type of coffee;
number of pulsing cycles, timing, and/or pattern of pulsing of the water from the spray head over the ground coffee in the funnel;
volume of bypass water;
number of pulsing cycles, timing, and/or pattern of pulsing of bypass water;
volume of dilution water;
number of pulsing cycles, timing, and/or pattern of pulsing of the dilution water;
operation of the air pump to increase or relieve pressure; and
number of pulsing cycles and/or timing of the air pump, and/or pattern of water dispensed from the spray head under the influence of the controllable operation of the air pump.

All of these recipe elements can be discretely controlled by the owner of the apparatus to develop nuanced and unique recipes for their operation to create a variety of resultant beverages to maximize the characteristics of the coffee used in the brewing process. Furthermore, design of the recipe architecture and programming of these recipes for control at the user interface 40 provides enhanced consistency in the brewing merely by having the employee check that the proper type of coffee and volume of that coffee is placed in the funnel. All of the rest of the controls are operated by the apparatus 20 once again enhancing the consistency and reducing interference with the process. This is in contrast to other brewing processes that are highly dependent upon employee interaction with the water, ground coffee, containers and related activities.

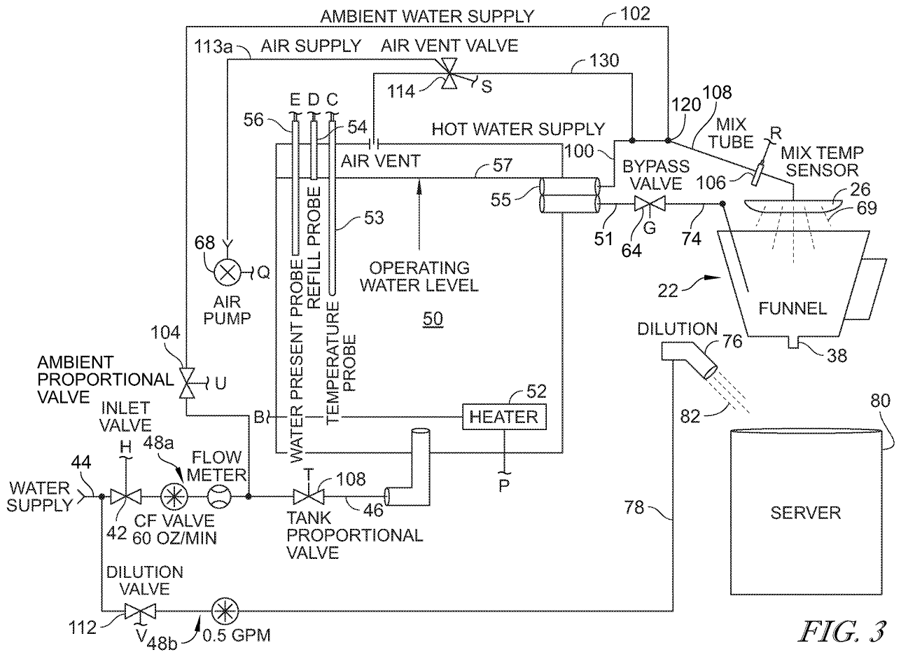

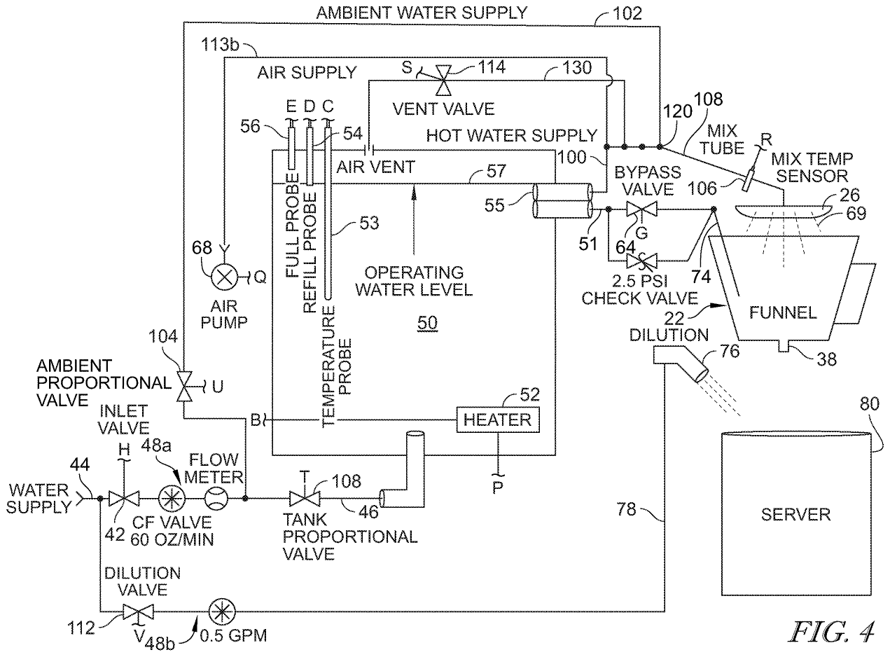

With reference to FIG. 3, the system operates using many of components and features disclosed in FIGS. 1 and 2 and as such to the degree there is commonality between the systems descriptions of the features will not be repeated. The description set forth herein with regard to FIGS. 1 and 2 also correlate to and transfer to FIGS. 3 and 4. Where FIGS. 3 and 4 have some additional structures or differences, the terms defined in FIGS. 1 and 2 will be applied to FIGS. 3 and 4. Where needed, similar structures or functions will be identified by corresponding reference numbers which may include the addition of a “reference letter” such as flow control 48a and flow control 40b as shown in FIGS. 3 and 4. While the funnel 22 is shown diagrammatically and FIGS. 3 and 4, it is in it is understood to include all of the additional structures and features as presented in more detail in the description with regard to FIG. 1.

As shown in FIG. 3, the system includes two controllable proportional valves, a flow meter, and a controllable tank vent valve. When controllably operating the two proportional valves, one proportional valve for the hot water, one proportional valve for the ambient water, the proportional valves are controllably operated opened and closed. This is generally in response to the temperature sensed by the temperature sensor at the output valve before mixing with the beverage making substance, for purposes of example, ground coffee. This assures that the approximate predetermined temperature is achieved for brewing the coffee according to a predetermined recipe. When controllably proportioning hot water to the mix tube the tank vent valve is closed and water is pushed out of the tank. The controllable ambient water proportioning valve works in a similar manner. When hot water is being dispensed via the controllable proportional hot water valve, the bypass water is prohibited from flowing.

When the bypass valve is operated the two proportional valves

are closed. Controllable operation of the bypass water allows it to flow through the bypass line and around the ground coffee bed using for brewing. In this operating mode, bypass water, the tank vent valve is opened and the bypass water is dispensed around the grounds through gravity flow. Water flowing from the system, whether it be controllably mixed temperature water or bypass water, flows through the funnel, in its respective path, and out through the drain at the bottom of the funnel.

This beverage making system allows for brewing temperatures from approximately 100 degrees F to approximately 205/207 degrees F. The use of two controllable proportional valves improves the control and accuracy of the predetermined recipe water temperature. This occurs in combination with the temperature sensing at the mix temperature sensor on the mixed tube. In addition, the flow meter helps monitor the flow of the water flowing through the inlet valve to manage the volume portion of the water calculation. This is used to manage irregular flows into the system through the inlet water line. The controller uses signal information detected by eh mix temperature sensor to calculates the volume of water that can flow through either or both the controllable ambient water proportional valve or the controllable hot water proportional valve. Calculation of the temperature will be processed by the controller which receives generally real time, generally continuous information from the mix temperature sensor. If the temperature of the water exiting the mixed temperature line rises above the predetermined target temperature, the tank proportional valve is closed completely or to some degree to help manage the temperature. Doing so will reduce the temperature since proportionally more ambient water will flow through the controllable ambient proportional valve. If the temperature of the water flowing past the mix temperature sensor falls below the predetermined recipe water temperature target, the ambient proportional valve can be closed completely or to some degree to proportionally increase the flow of water into the hot water tank and thereby driving more heated water into the mix water line. The use of these two controllable proportional valves helps to balance and regulate the temperature detected at the mix temperature sensor in a highly accurate manner.

The vent valve coupled to the air vent of the tank is normally open when not brewing. However, when brewing is initiated, the valve is controlled by the controller into the closed position. The bypass water using a controllable bypass valve is controlled off when mixed temperature water is used during the brewing cycle. The mixed temperature water being used during a brew cycle can be stopped to allow a moment of steep time or settling time in the grounds bed, and the bypass can be controlled open to allow bypass water to flow during this period. In this regard, there are multiple ways to control the valves to control the result and brew product.

As an additional matter, the dilution valve is positioned upstream of the inlet water control valve and flows through a separate line. A constant flow valve is provided in the path of the water flow for the dilution line to maintain a predetermined constant flow rate. This is used to provide dilution water to the server for mixing with the brewed coffee. By introducing the dilution valve upstream of the inlet valve, the controllable operation of the dilution valve during a brew cycle should not interfere with the controlled flow when the inlet valve is open. In this regard, the flow meter detects the flow rate of water in the inlet line. If the flow meter detects a higher flow the dilution valve is closed or a lower flow if the dilution valve is opened. In addition, a constant flow valve is provided between the inlet valve and the flow meter communicating with both the ambient water line and the heated water line to provide generally consistent flow through the inlet line.

As shown in FIGS. 3 and 4, a mix tube 108 extends from the water supply line 100 leading from the reservoir 50. Ambient water is controllably dispensed through the ambient water line 102 by control of the ambient proportional valve 104 over line U connected to the control board 60. The temperature sensor 106 communicates with the mix tube 108 to detect the temperature of water flowing through the mix tube 108. The mix temperature sensor 106 communicates over line R to the control board 60.

As heated water flows from the reservoir 50 through line 100 and ambient water flows through line 102, both sources of water meet in the mix tube 108 to mix and achieve a combined temperature. The combined temperature is lower than the heated water flowing through heated waterline 100 due to the reduced temperature of the ambient water supply 102. The mix temperature sensor 106 detects the temperature of the combined water paths joined at intersection 120 and provide provides feedback over line R to the controller 60. The controller 60 can then manage the water temperature by controllably operating the proportional ambient valve 104 and the tank proportional valve 108. The ambient proportional valve 104 is controlled over line U coupled to and communicating with the controller 60 and the tank proportional valve 108 is controlled over line T coupled to and communicating with the controller 60.

As set by the recipe controlled by the controller, a predetermined portion of dilution water may be added to the combined mixture flowing through the funnel 22. The dilution water is controlled at the dilution valve 112 over line V. Flow controls 48a and 48b are provided on the inlet water path 46 and the dilution path 78, respectively.

The diagram as shown in FIG. 4 is generally consistent with FIG. 3 with the modification of the air supply path. While the path in FIG. 3 connects the air pumped from the air pump 68 through the vent valve 114. The air supply line 113b in FIG. 4 connects to the inlet waterline 100 feeding the mix tube 108. This path separates the air supply from the air pump 68 from the vent valve 114 connected to the reservoir 50. The position of the air supply line 113b connecting to the inlet waterline 100 upstream of the vent valve discharge line 130 facilitates movement of steam from the reservoir 50 into the mix tube 108 for discharge there through.

The mix tube 108 is sloped downwardly from the mixing point 120 or intersection where the ambient water supply 102 and the heated water supply 100 come together toward the spray head 26. The slope prevents a vacuum lock in the tube 108 and promotes draining of the mixing tube 108 at the end of the brew cycle.

As a lower brewing temperature can be useful in many situations, a low temperature based on the incoming ambient water temperature can be used as a baseline for the lowest possible temperature water available for brewing. This temperature can be sensed by the mixed tube sensor 106 overline R connected to the controller 60. This will provide a baseline for brewing temperatures until there is a change in the ambient temperature. As an example, if the ambient water temperature is 80° F. in a location during the summer that would be the coolest temperature at which coffee could be brewed. However, the lowest temperature for brewing will be set at one of the temperatures described in the brewing range. As such, in virtually all situations some heated water will be added to the mix tube 108 over line 100 for combination with the ambient water.

The heated water and the ambient water are mixed in the mix tube 108 and the sensor 106 detects an accurate temperature of the combined water. If the temperature trends a rising temperature at the mix sensor 106, the proportional ambient valve 104 is controlled by the recipe being used by the controller to control the proportional ambient valve 104 to allow additional lower temperature ambient water to be introduced. For some brewing ingredients a lowest brewing temperature might be preferred to use as a lowest temperature lockout boundary. As an example, a cold brew temperature lockout can be set at the controller 60 for tea, perhaps at a level of 140° F. This might be set at this temperature due to the manner in which tea is handled prior to brewing. In contrast, the brewing temperature for coffee might be set below the 140° F. temperature since coffee is handled in a different manner (air drying, roasting, grinding, etc.) and is not subject to as organics or other substances remaining on the ground coffee as might be found on tea. As such the temperature for lower temperature brewing of coffee could be reduced below 140° F. However, a lockout temperature could be set so that the temperature does not go below the predetermined lockout temperature for coffee. The lockout temperature will be programmed at the controller 60.

The embodiments disclosed in the present application, provide a multi-temperature brewing apparatus that can brew back-to-back brew cycles on demand. These apparatus also provide multiple temperatures of brewing and multiple finished volumes. The controllable elements of the present apparatus allow it to brew at controllably different temperatures, controllably different volumes, and at controllably different times during a single brewing cycle providing maximum control of brewing recipes. There is little if any wait time between brews for recovery of the heated water reservoir. In contrast to prior art, there is virtually no time necessary to fully reset the heated water reservoir to either allow it to cool down or heat up to a different temperature since the temperature is controlled by the combination of the heated water and the ambient water detected by the mix temperature sensor and controlled to be within an acceptable range or temperature window relative to a predetermined target temperature. The present apparatus allows for a generally real time controllable adjustment to the temperature to achieve a predetermined target temperature output to the volume of brewing substance to be infused by the heated water. The brewing system can brew at temperatures from approximately 100 F to approximately 205/207 F. The apparatus can be used for brewing multiple types of beverages, including coffee, tea, tisanes, as well as other types of beverages, brewing substances, currently known or here after discovered, as well as other beverages for purposes of mixing such as powdered lemonade or other flavored drinks.

The present apparatus streamlines operation efficiencies by providing a single apparatus, with a relatively small footprint, to offer a wide variety of beverages, brewing controls to help optimize brewing extraction, and providing on demand control of energy consuming features so as to optimize the overall energy efficiency of the apparatus. An example of these efficiencies include providing large back-to-back quantities of beverage on demand to meet peak cycle controls while providing a variety of recipe controls to promote optimal flavor extraction, as well as optimal economic and cost efficiency extraction. This level of control of various timing, for various volumes, for various temperatures throughout a brew cycle help to optimize a recipe's flavor profile as well as optimize the cost efficiency of beverage production. These controls can also be used to scale up or scale down a batch recipe to meet the on demand needs, for example, to produce a half gallon, 1 gallon, or 1 ½ half gallon of beverages on demand, as well as producing a single cup of beverage on demand using the proportional same parameters to achieve the same, predictable recipe result. The controllability of this brewing apparatus also allows the operator to cater to consumer preferences and changes in consumer preferences overtime without changing equipment. All of the benefits of the present apparatus provide cost savings, energy, efficiency, product, consistency, and operational flexibility possibly consolidating several machines into a single machine using less counter space. The operational efficiencies may allow the operator to add other apparatus for other types of foods or beverages to complement the variety of production of beverages using this single apparatus.

An example of a coffee brew cycle includes setting up the brew filter with a beverage brewing substance retained within the filter. Insertion of the filter to the machine readies the machine for the brewing cycle. Once the brewing operation starts the system will adjust the brew water temperature using the multiple controllable proportional valves. This includes the ambient proportional control valve and the tank proportional control valve. Using feedback from the mix temperature sensor on the mix tube, communicating with the spray head, the mixed temperature sensor controllably adjusts the ambient and tank proportional valves to open or closed, partially or fully, to allow greater or less water from each line to be mixed to achieve the predetermined water temperature target range used during that portion of the brewing cycle.

In a similar manner, tea brewing can be optimized, using the controllable proportional valves to adjust the temperature of the water used to brew the tea during a brewing cycle. Similar to a coffee brewing cycle, a tea brewing cycle may require the tea to be initially wetted to bloom with a pause in the brewing process to allow the initial bloom of flavor to drain from the funnel. Subsequent pulses for possibly different durations of time for each pulse, with possibly different duration pauses in between such pulses, may be continued to complete a brewing cycle. Each of the pulses may also be for a predetermined length of time and a predetermined temperature. The controllable proportional valves are operated to adjust the temperature of the water used to brew the beverage to try to achieve a predetermined temperature.

In a similar manner, a funnel of known construction may be used with the bring apparatus for use in producing a beverage from powdered ingredients. As an example, the present apparatus can be used to produce a lemonade from a powdered beverage mix. It should be known that the beverages anticipated be produced by this apparatus are not limited to lemonade in this example and rather, any flavor of beverage, which can be produced from a powdered, gel, crystalline, or other form of substance, which is generally dissolved during the production of the beverage and drain from the funnel into the corresponding server.

Using the apparatus for such a powdered beverage, in this example lemonade, helps benefit the production of the substance. As an example, a predetermined volume of heated water may be applied to the beverage powder substance to help to dissolve sugars or other ingredients within the beverage substance. This may help to introduce the solid material into suspension within water. Using heated water in this manner may be helpful to produce the beverage. However, some substances may not benefit from rapid or continuous heating. As such the temperature could be predetermined to a temperature that is defined by the manufacturer of the ingredients to optimize the flavor of the resultant beverage. In addition, the funnel can be designed in a manner which does not allow for rapid flow out of the funnel container. Rather, the funnel of known design allows for a controlled flow out of the container. In this regard, the material that is now suspended in liquid can be introduced to the server. During the production of such a beverage from a powdered source, the dilution line can be controllably operated to allow a predetermined quantity of dilution water to be introduced into the server to dilute the beverage, the powdered ingredients of which have been dissolved into suspension in the beverage water. The flow out of the funnel and combination with the dilution flow can result in a combination of the ingredients, the dissolved powdered beverage, and the dilution water to help mix the ingredients to produce the final beverage with little if any additional mixing by operator interaction. These features help the apparatus operate in a generally automatic fashion minimizing the amount of labor required for the operation of the apparatus and the production of beverages, freeing labor to work on other aspects of the business at which the apparatus operates.

As will be appreciated, the foregoing general examples benefit from the highly controllable and precise operation of the various components and characteristics of the brewing apparatus. These controls and characteristics include controllable water temperature, dispense to the funnel set to achieve generally consistent temperatures predetermined as part of a recipe during all or portions of a brew cycle.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation so as to encompass all such modifications and equivalent structures and functions.

1. A beverage making apparatus comprising,
a heated water reservoir;
a water inlet line communicating with the heated water reservoir;
a controller for controlling operation of the apparatus;
a controllable water inlet line valve controllably communicating with the water inlet line and the water reservoir, the controllable water inlet line valve controllably coupled to the controller;
a controllable heater operatively coupled to the heated water reservoir for controllably providing energy to water in the heated water reservoir, the heater controllably coupled to the controller to controllably heat water retained within the water reservoir within a target range of approximately 100° F. to 207° F.;
a heated water controllable proportional valve communicating with heated water reservoir for controllably dispensing a controlled volume of water from the heated water reservoir to the beverage making substance;
an ambient water controllable proportional valve communicating with the inlet water line for controllably dispensing a controlled volume of water from the inlet water line to the beverage making substance;
the heated water line and the ambient water line both communicating with a mix water line for mixing prior to dispensing into the funnel;
a temperature sensor coupled to and detecting the temperature of water in the mix water line and communicating with the controller for facilitating control of the two controllable proportional valves to controlling the temperature of the water dispensed from the mix water line into the funnel
a housing of the apparatus, the heated water reservoir being at least partially contained in the housing;
a funnel for retaining a dose of beverage making substance for making beverage by addition of water, the funnel being removably attachable to the housing;
a server positioned relative to the funnel for receiving beverage dispensed from the funnel as a result of the infusion of water with the beverage brewing substance retained within the funnel;
a spray head communicating with at least the heater water reservoir for distributing water from the reservoir to the beverage brewing substance retained within the funnel;
a controllable bypass valve controllably coupled to the controller and communicating with the heated water reservoir for controllably dispensing water from the heated water reservoir to the funnel in a path separate from the spray head and delivering water generally separate from the beverage making substance, but for delivery through the funnel and into the server; and
a dilution water inlet valve coupled to the inlet line and controllably connected to the controller for operatively controlling the flow of dilution water to the server for mixing with beverage already dispensed from the funnel.
